(19) United States
(12) Patent Application Publication
(10) Pub. No.: US 2013/0262779 A1
(43) Pub. Date: Oct. 3, 2013

(54) PROFILE-BASED HARDWARE PREFETCHING

(71) Applicants: Jayaram BOBBA, Portland, OR (US); Ryan CARLSON, Hillsboro, OR (US); Jeffrey Cook, Hillsboro, OR (US); Abhinav DAS, San Jose, CA (US); Jason HORIHAN, Hillsboro, OR (US); Wei LI, Palo Alto, CA (US); Suresh SRINIVAS, Portland, OR (US); Sreenivas SUBRAMONEY, Bangalore (IN); Krishnaswamy VISWANATHAN, Portland, OR (US)

(72) Inventors: Jayaram BOBBA, Portland, OR (US); Ryan CARLSON, Hillsboro, OR (US); Jeffrey Cook, Hillsboro, OR (US); Abhinav DAS, San Jose, CA (US); Jason HORIHAN, Hillsboro, OR (US); Wei LI, Palo Alto, CA (US); Suresh SRINIVAS, Portland, OR (US); Sreenivas SUBRAMONEY, Bangalore (IN); Krishnaswamy VISWANATHAN, Portland, OR (US)

(21) Appl. No.: 13/436,790

(22) Filed: Mar. 30, 2012

(51) Int. Cl. G06F 12/00; G06F 12/08

(52) U.S. Cl. 711/137; 711/154; 711/E12.001; 711/E12.057

(57) ABSTRACT

Profiling and analyzing modules may be combined with hardware modules to identify a likelihood that a particular region of code in a computer program contains data that would benefit from prefetching. Those regions of code that would not benefit from prefetching may also be identified. Once a region of code has been identified, a hardware prefetcher may be selectively enabled or disable when executing code in identified code region. In some instances, once a processing device finishes executing code in the identified code region, the state of the hardware prefetcher may then be switched back to its original state. Systems, methods, and media are provided.

### BACKGROUND

Hardware prefetchers have been used in processing devices to cache data before it is actually used by a computer program to improve performance and minimize data retrieval delays. Typically, hardware prefetchers have been implemented using basic pattern matching algorithms that are used to determine the memory addresses at which prefetching is to be implemented. Once a memory access pattern has been identified, the prefetchers typically automatically begin prefetching data according to the identified pattern even if the prefetched data is not actually used during the execution of a computer program.

In those situations where the prefetched data is not actually used by the computer program, the prefetched data is still retrieved and stored in a cache by the prefetcher. Since these caches often have a limited memory, other data that is actually used may be removed or evicted from the cache in order to make room for the prefetched data that is not used. Additionally, memory bandwidth that could otherwise be used during execution of the computer program is instead diverted to prefetching data that is not subsequently used. In memory bandwidth limited and/or cache-constrained applications, this may lead to significant performance loss and power inefficiencies, causing some users to disable hardware prefetching altogether.

There is a need for more sophisticated hardware prefetching that is able to selectively enable or disable prefetching to improve performance.

### BRIEF DESCRIPTION OF THE DRAWINGS

FIG. 1 shows a block diagram of a computer system in an embodiment of the present invention.

FIG. 2 shows an exemplary process according to an embodiment of the present invention.

FIG. 3 shows an exemplary region of code, a generic memory access pattern, and two sets of memory address accesses when executing the region of code according to an embodiment of the present invention.

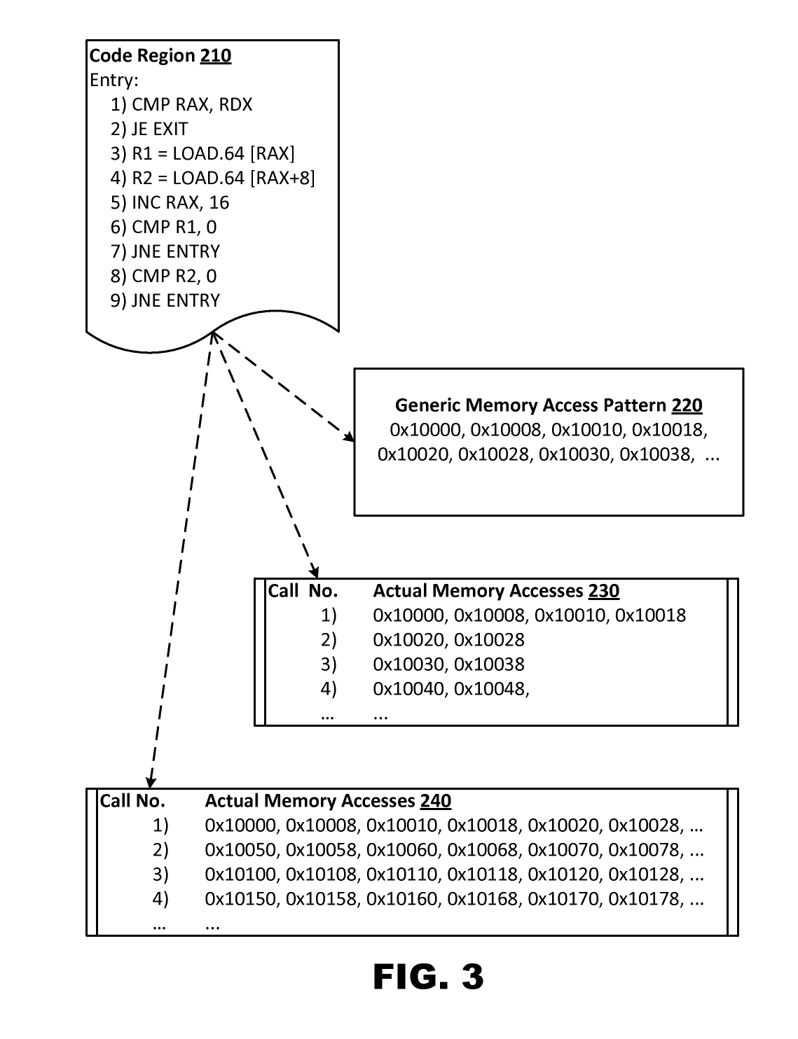

FIG. 4 shows an example architecture of a system according to an embodiment of the present invention.

FIG. 5 shows an exemplary embodiment of the invention.

### DETAILED DESCRIPTION

In an embodiment, regions of code in a computer program that would benefit or not benefit from prefectching may be identified. A particular region of code may benefit from prefetching if the data is likely to be used by the computer program after being prefetched. If the data is not likely to be used by the computer program after being prefetched then the region of code likely may not benefit from prefetching. This determination may be made by identifying a rate at which memory addresses in a region of code that are subject to prefetching are actually read and used as the computer program is being executed. Memory address data that is rarely used need not be prefetched, while memory address data that is frequently used or read may be more suitable for prefetching.

Once a region of code in the computer program that would benefit from prefetching has been identified, the hardware prefetcher may be selectively enabled to prefetch data in an identified code region. Once a processing device finishes executing code in the identified code region, the hardware prefetcher may be selective disabled.

In other instances, the hardware prefetcher may also be selectively disabled when executing a particular region of code, if it is determined that the data in the region of code is not likely to be used after being prefetched by the hardware prefetcher. Once a processing device finishes executing code in the identified code region, the hardware prefetcher may be selectively enabled.

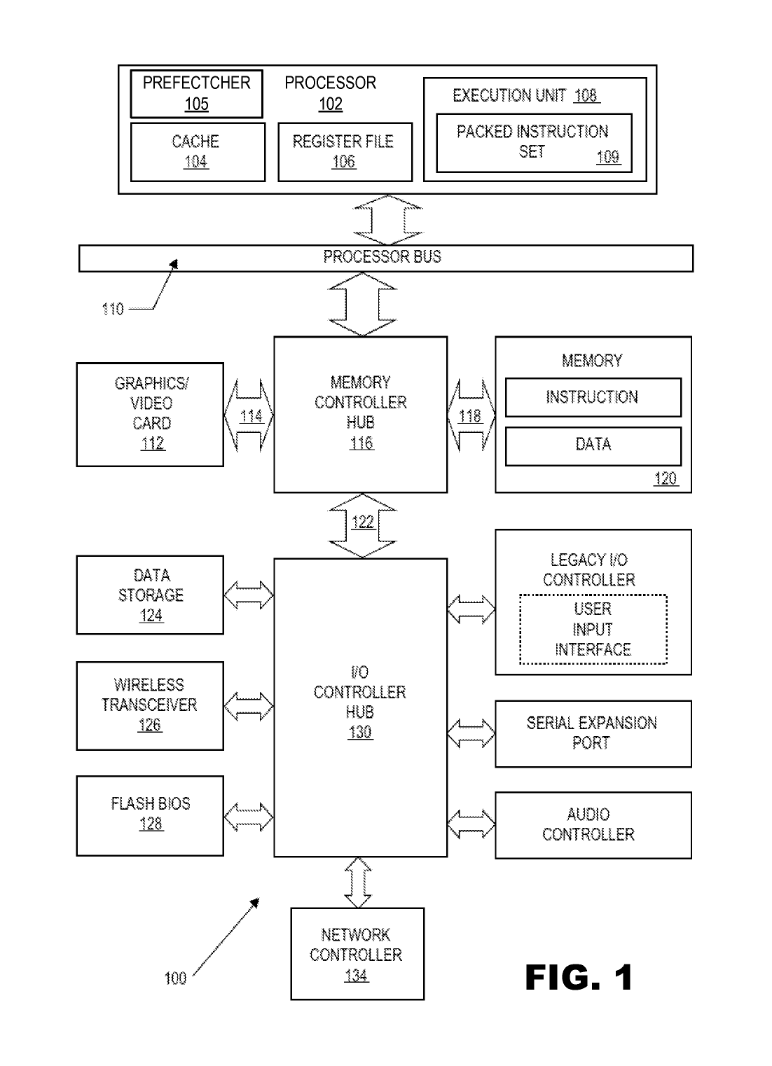

FIG. 1 shows a block diagram of an exemplary computer system formed with a processor that includes execution units to execute an instruction in accordance with one embodiment of the present invention. System 100 includes a component, such as a processor 102 to employ execution units including logic to perform algorithms for process data, in accordance with the present invention, such as in the embodiment described herein. System 100 is representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

FIG. 1 shows a block diagram of a computer system 100 formed with a processor 102 that includes one or more execution units 108 to perform an algorithm to perform at least one instruction in accordance with one embodiment of the present invention. One embodiment may be described in the context of a single processor desktop or server system, but alternative embodiments can be included in a multiprocessor system. System 100 is an example of a ‘hub’ system architecture. The computer system 100 includes a processor 102 to process data signals. The processor 102 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that can transmit data signals between the processor 102 and other components in the system 100. The elements of system 100 perform their conventional functions that are well known to those familiar with the art.

In one embodiment, the processor 102 includes a Level 1 (L1) internal cache memory 104. Depending on the architecture, the processor 102 can have a single internal cache or multiple levels of internal cache. Alternatively, in another embodiment, the cache memory can reside external to the processor 102. Other embodiments can also include a combination of both internal and external caches depending on the particular implementation and needs. Register file 106 can store different types of data in various registers including integer registers, floating point registers, status registers, and instruction pointer register.

In an embodiment, the processor 102 may include a hardware prefetcher 105 that may be configured to read and/or cache data, such as in cache memory 104, before the data is actually used in order to improve performance and minimize data retrieval delays.

Execution unit 108, including logic to perform integer and floating point operations, also resides in the processor 102. The processor 102 also includes a microcode (ucode) ROM that stores microcode for certain macroinstructions. For one embodiment, execution unit 108 includes logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of an execution unit 108 can also be used in micro controllers, embedded processors, graphics devices, DSPs, and other types of logic circuits. System 100 includes a memory 120. Memory 120 can be a dynamic random access memory (DRAM) device, a static random access memory (SRAM) device, flash memory device, or other memory device. Memory 120 can store instructions and/or data represented by data signals that can be executed by the processor 102.

A system logic chip 116 is coupled to the processor bus 110 and memory 120. The system logic chip 116 in the illustrated embodiment is a memory controller hub (MCH). The processor 102 can communicate to the MCH 116 via a processor bus 110. The MCH 116 provides a high bandwidth memory path 118 to memory 120 for instruction and data storage and for storage of graphics commands, data and textures. The MCH 116 is to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip

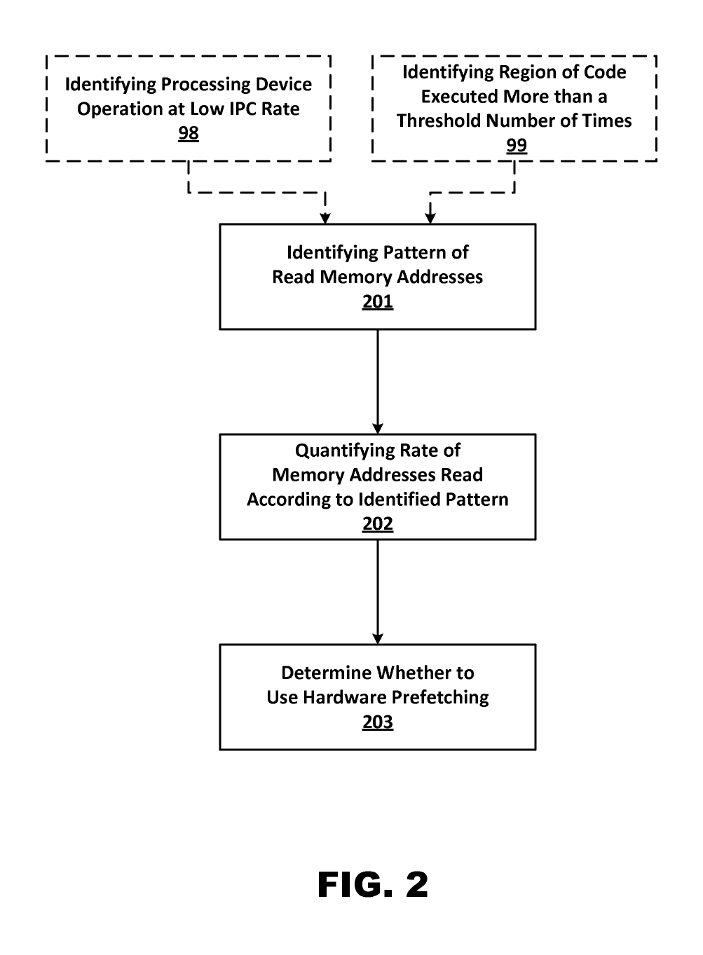

FIG. 2 shows an exemplary process in an embodiment. In box 201, a pattern of memory addresses read during execution of a designated code region of a computer program may be identified. The pattern may be determined from a sequence in which the memory addresses are read each time the designated code region is executed. The pattern may be one of a predetermined set of patterns. The pattern may be identified during the first time that the designated code region is executed by comparing the sequence in which the memory addresses are read to the predetermined set of patterns to identify a matching pattern.

Once a memory access pattern has been identified, in box 202, a rate at which the memory addresses are read according to the identified pattern may be quantified. The rate may be calculated by counting a number of times the memory addresses are read according to the identified pattern when executing the designated region of code. This count may be then compared to the total number of times or iterations that the designated region of code is executed to quantify the rate.

In some instances, a delay may be inserted during the counting so that the counting process may, upon counting an instance when the memory addresses are read according to the identified pattern, wait until a predetermined number of subsequent instructions have been executed before counting a subsequent instance when additional memory addresses are read according to the identified pattern. This may be done to ensure that each call of the designated region of code in a particular section of the computer program is counted only once. In some instances, the predetermined number of instructions that the counting process may wait may be on the order of about 10,000 instructions.

If the memory addresses are read according to the identified pattern almost each time the designated region of code is executed or iterated, then the quantified rate may be close to 100%. If, however, the computer program does not loop or repeat the reading of memory addresses according to the identified pattern when executing the designated region of code, then the quantified rate may be equivalent to or closer to zero.

In some instances, to keep track of the quantified rate as the computing program is being executed, an identifier of each identified pattern in box 201 may be included in a table. The identifier in the table may be moved up in rank each time memory addresses are read according to the identified pattern when the designated region of code is being executed.

Once the memory address read rate has been quantified in box 202, in the box 203 a determination may be made as to whether hardware prefetching should be enabled or disabled. The determination of whether to use hardware prefetching may be based on the quantified rate determined in box 202.

If the quantified rate is relatively high, then memory addresses may be frequently read according to the identified pattern. This means that prefetched memory address data may be frequently used, so a net performance gain may result from enabling prefetching.

On the other hand, if the quantified rate is relatively low, then memory addresses may be infrequently read according to the identified pattern. In this situation, it is more likely that prefetched memory address data may remain unused, resulting in no benefits from prefetching. Prefetching may therefore be disabled or otherwise not used.

In some situations, prefetching may be enabled by default. In these situations, prefetching may remain active and enabled unless it is determined that the quantified rate is low enough to warrant disabling prefetching. This may occur if the quantified rate is less than a threshold value such that the threshold value exceeds the quantified rate. In this case, hardware prefetching may be disabled while the designated region of code is being executed and the re-enabled after the designated region of code is finished executing.

In other situations, the reverse may occur, as prefetching may be disabled by default. In these situations, prefetching may remain unused and disabled unless it is determined that the quantified rate is high enough to exceed a threshold value and justify enabling prefetching. In this case, hardware prefetching may be enabled while the designated region of code is being executed and then re-disabled after the designated region of code is finished executing.

In some situations, the higher the rate at which memory addresses are read according to the identified pattern, the greater the benefits from enabling prefetching. A tiered approach may also be provided that varies the amount of data that is prefetched based on the quantified rate at which memory addresses are read according to the identified pattern. For example, if the quantified rate exceeds a first threshold value, then the prefetching of data from at least one memory address according to the identified pattern may be enabled. However, if the quantified rate also exceeds a second threshold value that is higher than the first threshold value, then additional data from at least one additional memory address may also be prefetched according to the identified pattern. Thus, when the second, higher threshold value is exceeded, the prefetching of data may be expanded so that more data is prefetched than if only the first, lower threshold value is exceeded.

Regions of code in a computer program may be identified based on entry points to enter a code region and exit points to leave a code region. Each region of code may include at least one backwards loop or branch. Each region of code may be bound by those instructions included within a selected outermost backward loop. Entry points may act as lead-ins to an instruction within the loop while exit points may act as redirectors to an instruction outside the loop.

These various entry and exit points in the computer program for a designated region of code may be identified and then the identified entries and exits may be included in a block table. The block table may be used to determine whether an instruction being executed is in a designated region of the code. An instruction point of a back edge of an outermost loop in a designated region of code may be included as an identified exit in the block table. The entry and/or exit points included in the block table may be used to form a branch profile of the loop and the designated region of code. The branch profile may be used to identify the possible paths in the designated region of code that may be traversed.

Additionally, during execution, an entry point to the designated region of code in the computer program may be identified. Once the entry point is identified, a memory location containing the block table defining the designated region of code may be looked up. The block table may be accessed and a branch profile may be retrieved from the block table for the designated region of code from the block table. A hardware prefetching setting may then be switched between enabled and/or disabled when entering the designated region of code according to the entry point and then when exiting the designated region of code according to the branch profile. The switching may be determined based on the quantified rate determined in box 202.

In some instances, one or more additional steps, such as shown in boxes 98 or 99, may be performed before spending resources to identify memory address read patterns in box 201 and/or perform the other steps in boxes 202 and 203. In box 99, a region of code in the computer program that is executed more than a first threshold number of times may be identified. This identified region of code may then be designated as the designated region of code. This additional step may be taken to ensure that only those regions of code that are frequently called are classified as possible candidates for prefetching. If a region of code is only executed on rare occasions, prefetching may not yield the same performance gains as if the region of code were more frequently executed, assuming that there are sufficient gains to be realized from prefetching.

Additionally, in some instances, prefetching may not yield substantial performance gains. For example, if a processing device executing the computer program is already processing a high number of instructions per clock cycle (IPC), then the processing device may be able to direct a reading of the memory addresses from a memory device without the need for prefetching and caching the data from the memory addresses. This is because the performance gains from prefetching and caching are likely to be low given the high IPC rate at which the processing device is operating.

However, if the processing device is operating at a much lower IPC rate, then the rate may be improved by prefetching and caching memory address data to avoid the need for the processing device to spend its time performing this ancillary task. Thus, processing performance gains from prefetching and caching are likely to be much higher given low IPC rates.

In box 98, the number of instructions per clock cycle (IPC) processed by a device executing the computer program may be quantified. The methods and processes described herein, including the steps associated with boxes 201, 202, and/or 203, may be performed when the IPC is less than a threshold value.

FIG. 2 shows an exemplary region of code 210, a generic memory access pattern 220, and two sets of memory address accesses 230 and 240 from executing the region of code 200. The code in this exemplary region 210 reads two successive memory addresses, the second eight bits after the first. After reading the two successive memory addresses, the contents of the two memory addresses are checked to determine whether they are both zero. If the contents of both memory addresses, are zero, then the code in this region 210 is finished and the process exits from code region 210. If the contents of at least one of the memory addresses is not zero, then the process repeats, loading the next two successive memory addresses after the two that were already read and compared. These next two memory addresses are then checked to determine whether they are both zero. If the contents of both memory addresses, is zero, then the code in this region 210 is finished and the process exits from code region 210. If the contents of at least one of the memory addresses is not zero, then the process repeats after loading the next two successive memory addresses, and so on.

During execution, the memory addresses that are accessed may be analyzed to identify a generic pattern 220. In one example, if the region of code 210 starts with loading memory address 0x10000, then the next address 0x10008 will also be loaded. If the contents of these addresses are both non-zero, then the next addresses 0x10010 and 0x10018 will be loaded next. If the contents of these addresses are both non-zero, then the next addresses 0x10020 and 0x10028 will be loaded next, and so on. This process of loading the next two addresses may continue until both of the addresses are zero, at which time the program may exit the region of code 210.

In this example, the generic pattern 220 may suggest prefetching the next two addresses (such as 0x10010 and 0x10018) each time a pair of addresses are loaded (such as 0x10000 and 0x10008). Prefetching these addresses in advance may ensure that the memory address contents are immediately available for comparing when the process loops so that additional processing time is not spent waiting for the contents to be retrieved from memory. However, in those instances where the process often exits code region 210 without looping, prefetching need be performed.

While the computing program is executing, the region of code 210 may be called multiple times. If most of the memory addresses contain zeros, then the likelihood of the code 210 trigger a loop to retrieve the contents of additional memory addresses is also low. For example, if the memory addresses at and above address 0x10010 all contain zeros, then each time code region 210 is called and memory addresses at address 0x10010 or higher are loaded, the program will immediately exit code region 210 without looping or reading additional memory addresses (since the memory addresses all contain zeros).

Thus, as shown in the actual memory access table 230, the first time code region 210 is called to load memory addresses 0x10000 and 0x10008, which are both non-zero, the code will loop back and repeat with the next memory addresses 0x10010 and 0x10018. However, since these addresses and each of the higher addresses all contain zeros, the process will then exit code region 210 without loading further addresses. Each of the subsequent times that code region 210 is called to load higher memory addresses, the code may only load the first two addresses before exiting the code region 210 as the higher memory addresses all contain zeros in this example.

In this situation, it may be undesirable to prefetch the contents of the next two memory addresses, since, other than the first time code region 210 is called, the contents of these next two memory addresses are not used. Thus, the memory accesses shown in memory access table 230 is indicative of a situation in which prefetching should be disabled for at least code region 210.

If, however, most of the memory addresses do not contain zeros, then each time code region 210 is called, it is likely to loop several times, each time loading the next two sets of memory addresses, before exiting the region of code 210. Memory access table 240 shows an example in which most of the memory address contents are non-zero, except for memory addresses 0x10040 and 0x10048, 0x100F0 and 0x100F8, 0x10140 and 0x10148, 0x101F0 and 0x101F8, and so on. In this example, code region 210 will loop several times each time the code region 210 is called. Every time the code region 210 loops, the next two sets of memory addresses will be loaded and then compared.

In this situation, it may be desirable to prefetch the contents of the next two memory addresses, since each call of code region 210 involves loading and comparing several sets of memory addresses, ensuring that the contents of the prefetched memory addresses will be used in most instances. Thus, the memory accesses shown in memory access table 240 is indicative of a situation in which prefetching should be enabled for at least code region 210.

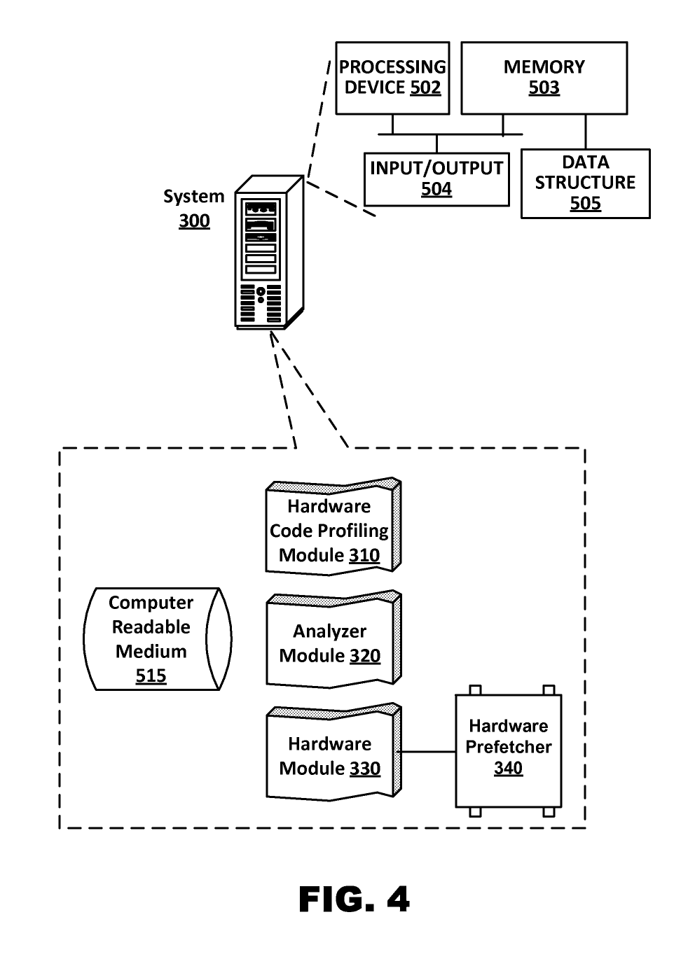

FIG. 4 shows an exemplary architecture of a system 300. System 300 may include a computer readable medium 515, a hardware code profiling module 310, an analyzer module 320, a hardware module 330, and a hardware prefetcher 340 that may include a cache for storing data. Hardware code profiling module 310 and an analyzer module 320 may include a combination of hardware and software. The software may be stored in the computer readable medium 515.

The hardware code profiling module 310 may be capable of identifying a pattern from a sequence of memory addresses read during execution of a designated region of code of the computer program. The hardware code profiling module may include an interface to receiving data read from the memory addresses during execution of the designated region of code. The hardware code profiling module 310 may identify the pattern from the sequence of memory addresses read during execution of a designated region of code of the computer program and then send the identified pattern to the analyzer module 320.

The analyzer module 320 may be capable of quantifying a rate at which memory addresses are read according to the identified pattern when executing the designated region of code. The analyzer module 310 may count a number of instances the memory addresses are read according to the identified pattern each time the designated region of code is executed. The analyzer module 310 may also count a number of instances the designated region of code is executed and then compare the counted numbers to quantify the rate. The analyzer module 310 may send the quantified rate information to a hardware module 330.

The hardware module 330 may include circuits, transistors, and/or other hardware capable of toggling the hardware prefetcher 340 between an enabled state and a disabled state. The hardware module 330 may determine whether to enable or disable the hardware prefetcher 340 during execution of the designated region of code based on the quantified rate. For example, if the quantified rate exceeds a particular threshold, the hardware module 330 may enable the hardware prefetcher 340 to prefetch data while the designated region of code is being executed. In other instances, if the quantified rate is less than a particular threshold, the hardware module 330 may disable the hardware prefetcher 340 to prevent the prefetching of data while the designated region of code is being executed.

System 300 may also contain a processing device 502, memory 503 storing loaded data or a loaded data structure 505, and an communications device 504, all of which may be interconnected via a system bus. In various embodiments, system 300 may have an architecture with modular hardware and/or software systems that include additional and/or different systems communicating through one or more networks.

Communications device 504 may enable connectivity between the processing devices 502 in system 300 and that of other systems (not shown) by encoding data to be sent from the processing device 502 to another system and decoding data received from another system for the processing device 502.

In an embodiment, memory 503 may contain different components for retrieving, presenting, changing, and saving data and may include the computer readable medium 515. Memory 503 may include a variety of memory devices, for example, Dynamic Random Access Memory (DRAM), Static RAM (SRAM), flash memory, cache memory, and other memory devices. Additionally, for example, memory 503 and processing device(s) 502 may be distributed across several different computers that collectively comprise a system.

Processing device 502 may perform computation and control functions of a system and comprises a suitable central processing unit (CPU). Processing device 502 may include a single integrated circuit, such as a microprocessing device, or may include any suitable number of integrated circuit devices and/or circuit boards working in cooperation to accomplish the functions of a processing device. Processing device 502 may execute computer programs, such as object-oriented computer programs, within memory 503.

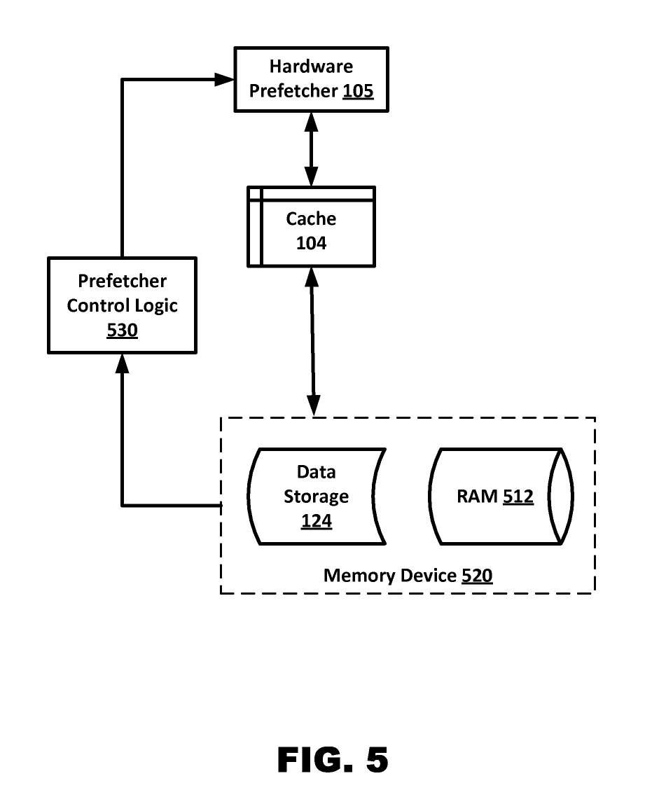

FIG. 5 shows an exemplary embodiment of the invention. A hardware prefetcher 105 may be coupled to a cache memory 104 and/or memory device 520. The hardware prefetcher 105 may be configured to prefetch data from the memory device 520 into the cache memory 104 when the hardware prefetcher is enabled. If the hardware prefetcher 105 is disabled, the prefetching and caching steps may be bypassed and the data may be read from the memory device 520 as though the hardware prefetcher 105 is not present. Memory device 520 may include non-volatile data storage 124, flash memory, random access memory 512, or other media.

Prefetcher control logic 530 may be used to generate a control signal for enabling and/or disabling the hardware prefetcher 105. Prefetcher control logic 530 may be configured to toggle the hardware prefetcher 105 between the enabled state and a disabled state. This toggling may occur in response to the prefetcher control logic 530 receiving an indication that a quantified rate at which memory addresses are read from a memory device 520 according to a predetermined pattern during execution of a designated region of computer program code has crossed at least one threshold.

In some embodiments a hardware rate unit may be used to quantify the rate at which the memory addresses are read according the predetermined pattern and determine whether the quantified rate crossed a threshold. The prefetcher control logic 530 may receive a result of the determination from the hardware rate unit as the indication that the quantified rate has crossed a threshold. In other instances a dynamic compiler, profiler or other code may be used to quantify the rate and determine whether the quantified rate has crossed a threshold. An indication of the determination may be provided to the prefetcher control logic 530 through an API, register write, new instruction, or hint. In some instances the indication of the determination may be provided to the prefetcher control logic 530 based on a software determination of the rate at which memory addresses in a region of code that are subject to prefetching are actually read and used as the computer program is being executed.

For example, if the prefetcher control logic 530 receives an indication that this quantified rate has exceeded a first threshold, the prefetcher control logic 530 may toggle the hardware prefetcher 105 to the enabled state. However, in some instances, if the prefetcher control logic 530 receives an indication that the quantified rate has dropped below a second threshold the prefetcher control logic 530 may toggle the hardware prefetcher 105 to the disabled state. In some instances the first threshold may be equal to the second threshold. In other instances, the first threshold may be greater than the second threshold.

The prefetcher control logic may be configured to toggle the hardware prefetcher to the enabled state during the execution of the designated region of computer program code after receiving an indication that the quantified rate has exceeded a first threshold. The prefetcher control logic may be configured to toggle the hardware prefetcher to the disabled state during the execution of the designated region of computer program code after receiving an indication that the quantified rate has dropped below a first threshold.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, the hardware prefetcher 105 may be directly coupled to a processing device 502 and/or cache 104, which may be include as part of the hardware prefetcher 105.

We claim:

1. A method for determining whether to use hardware prefetching during execution of a computer program comprising:
identifying a pattern from a sequence of memory addresses read during execution of a designated region of code of the computer program;
quantifying a rate at which memory addresses are read according to the identified pattern when executing the designated region of code; and
determining whether to use hardware prefetching during execution of the designated region of code based on the quantified rate.

2. The method of claim 1, further comprising:
identifying a region of code in the computer program executed more than a first threshold number of times; and
designating the identified region of code as the designated region of code.

3. The method of claim 1, wherein the designed region of code includes at least one backwards branch.

4. The method of claim 1, further comprising:
quantifying a number of instructions per clock cycle (IPC) processed by a device executing the computer program; and
performing the method of claim 1 when the IPC is less than a threshold value.

5. The method of claim 1, wherein quantifying the rate includes:
counting a number of instances the memory addresses are read according to the identified pattern when executing the designated region of code;
counting a number of instances the designated region of code is executed; and
comparing the counted numbers to quantify the rate.

6. The method of claim 5, wherein the counting includes, upon counting an instance when the memory addresses are read according to the identified pattern, waiting until a predetermined number of subsequent instructions have been executed before counting a subsequent instance when additional memory addresses are read according to the identified pattern.

7. The method of claim 6, wherein the predetermined number of subsequent instructions is on an order of about 10,000.

8. The method of claim 1, further comprising:
including an identifier of the identified pattern in a table; and
moving up the identifier in the table each time memory addresses are read according to the identified pattern during the execution of the designated region of code as part of the quantifying of the rate.

9. The method of claim 1, further comprising:
responsive to the quantified rate exceeding a first threshold, prefetching data from at least one memory address according to the identified pattern; and
responsive to the quantified rate exceeding a second threshold, prefetching data from at least one additional memory address according to the identified pattern.

10. The method of claim 1, further comprising, responsive to a first threshold exceeding the quantified rate:
disabling hardware prefetching during execution of the designated region of code; and
otherwise enabling hardware prefetching during execution of the computer program.

11. The method of claim 1, further comprising, responsive to the quantified rate exceeding a first threshold:
enabling hardware prefetching during execution of the designated region of code; and
otherwise disabling hardware prefetching during execution of the computer program.

12. The method of claim 1, further comprising:
identifying in the computer program entries to and exits from the designated region of code;
including the identified entries and the identified exits in a block table; and
determining whether the designated region of the code is being executed using the block table.

13. The method of claim 1, wherein an instruction point of a back edge of an outermost loop in a designated region of code is included as an identified exit in the block table.

14. The method of claim 1, further comprising:
identifying an entry point in the computer program to the designated region of code during execution;
looking up a memory location containing a block table defining the designated region of code;
retrieving a branch profile for the designated region of code from the block table;
switching the hardware prefetching between enabled and disabled when entering the designated region of code according to the entry point and exiting the designated region of code according to the branch profile.

15. A system comprising:
a hardware prefetcher;
a hardware code profiling module capable of identifying a pattern from a sequence of memory addresses read during execution of a designated region of code of the computer program;
an analyzer module capable of quantifying a rate at which memory addresses are read according to the identified pattern when executing the designated region of code; and
a hardware module capable of determining whether to use the hardware prefetcher during execution of the designated region of code based on the quantified rate and toggling the hardware prefetcher accordingly.

16. The system of claim 15, wherein the hardware code profiling module is further capable of:
identifying a region of code in the computer program executed more than a first threshold number of times; and
designating the identified region of code as the designated region of code.

17. The system of claim 15, wherein the designed region of code includes at least one backwards branch.

18. A non-transitory computer readable medium comprising stored instructions that when executed by a processing device, cause the processing device to:
identify a pattern from a sequence of memory addresses read during execution of a designated region of code of the computer program;
quantify a rate at which memory addresses are read according to the identified pattern when executing the designated region of code; and
determine whether to use hardware prefetching during execution of the designated region of code based on the quantified rate.

19. The non-transitory computer readable medium of claim 18, wherein the stored instructions, when executed by the processing device, cause the processing device to further:
identify a region of code in the computer program executed more than a first threshold number of times; and
designate the identified region of code as the designated region of code.

20. The non-transitory computer readable medium of claim 19, wherein the designed region of code includes at least one backwards branch.

21. An apparatus comprising:
a cache memory;
a hardware prefetcher configured to prefetch data into the cache memory in an enabled state; and
prefetcher control logic configured to toggle the hardware prefetcher between the enabled state and a disabled state responsive to an indication that a quantified rate at which memory addresses are read according to a predetermined pattern during execution of a designated region of computer program code has crossed at least one threshold.

22. The apparatus of claim 21, wherein the prefetcher control logic is configured to toggle the hardware prefetcher to the enabled state responsive to the indication indicating that the quantified rate has exceeded a first threshold and toggle the hardware prefetcher to the disabled state responsive to the indication indicating that the quantified rate has dropped below a second threshold.

23. The apparatus of claim 22, wherein the first threshold is equal to the second threshold.

24. The apparatus of claim 22, wherein the first threshold is greater than the second threshold.

25. The apparatus of claim 21, wherein the prefetcher control logic is configured to toggle the hardware prefetcher to the enabled state during the execution of the designated region of computer program code responsive to the indication indicating that the quantified rate has exceeded a first threshold.

26. The apparatus of claim 21, wherein the prefetcher control logic is configured to toggle the hardware prefetcher to the disabled state during the execution of the designated region of computer program code responsive to the indication indicating that the quantified rate has dropped below a first threshold.
